(19) United States
(12) Patent Application Publication
(10) Pub. No.: US 2005/0010722 A1
(43) Pub. Date: Jan. 13, 2005

(54) Multi-volume disk array management method and system

(76) Inventor: Chih-Wei Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/618,882

(22) Filed: Jul. 11, 2003

(51) Int. Cl. G06F 12/00

(52) U.S. Cl. 711/114; 711/173

(57) ABSTRACT

A multi-volume disk array management method and system is proposed, which is designed for use with a multi-disk storage unit, such as a RAID (Redundant Array of Independent Disks) unit, particularly a low-end RAID unit having a limited number of disks, for the purpose of allowing the low-end RAID unit to be nonetheless capable of providing two or more logical volumes for storing data of different levels of importance in different locations (i.e., different logical volume) with different levels of fault tolerance. This feature allows low-end RAID unit to be versatile in data storage.

### BACKGROUND OF THE INVENTION

1. Field of the Invention

This invention relates to information technology, and more particularly, to a multi-volume disk array management method and system, which is designed for use with a multi-disk storage unit, such as a RAID (Redundant Array of Independent Disks) unit, particularly a low-end RAID unit having a limited number of disks, for the purpose of allowing the low-end RAID unit to be nonetheless capable of providing two or more logical volumes for storing data of different levels of importance in different locations with different levels of fault tolerance.

2. Description of Related Art

RAID (Redundant Array of Independent Disks) is a multi-disk storage unit that contains two or more hard disks, and is commonly equipped to a network server to offer a very large data storage capacity. Though developed initially for servers and stand-alone disk storage systems, RAID is now increasingly becoming available in desktop PCs primarily for fault tolerance.

RAID has been standardized by the RAID Advisory Board. For details about the RAID standard, please refer to the RAID Advisory Board's publications or visit their Web site at www.raid-advisory.com. No detailed description of the RAID standard will be given here in this specification.

The RAID standard specifies a number of fault tolerance methods for the storage of data on a RAID unit, which are represented by different RAID levels, such as RAID Level 0 for disk striping only, which interleaves data across multiple disks for better performance, but provide no safeguards against failure; RAID Level 1 for disk mirroring on multiple disks; RAID Level 2 for interleaving data across multiple disks; to name a few. Commonly used RAID levels include RAID Level 0, RAID Level 1, RAID Level 2, RAID Level 3, RAID Level 4, RAID Level 5, RAID Level 6, RAID Level 10, and so on. For details about the storage methods at these RAID levels, please refer to the RAID Advisory Board's publications or any relevant references. No detailed description of these RAID levels will be given here in this specification.

In RAID applications, it is often needed to organize the storage space of one single RAID unit into two or more logical volumes and set each of these logical volumes to a specific RAID level, so that data of different levels of importance can be stored in different locations (i.e., logical volumes) in the RAID unit. For example, the storage space of a RAID unit can be organized into three logical volumes, wherein the first logical volume is set to RAID Level 0; the second logical volume is set to RAID Level 1; and the third logical volume is set to RAID Level 5.

One drawback to the foregoing practice, however, is that conventional RAID management utilities only allow one or more disks to be organized into one logical volume; i.e., each logical volume is composed of one or more hard disks; and therefore, it is only suitable for use on high-end RAID units (those with a large number of hard disks) and is unsuitable for use on low-end ones (those with only 4 to 6 hard disks). For a low-end RAID unit, it can provide only one logical volume, and not two or more logical volumes; and therefore, one single low-end RAID unit can only be set to-one RAID level, and not two or more RAID levels to store data of different levels of importance in different locations. This drawback undoubtedly makes low-end RAID unit lacks versatility in data storage.

### SUMMARY OF THE INVENTION

It is therefore an objective of this invention to provide a multi-volume disk array management method and system that allows a low-end RAID unit to be organized into two or more logical volumes which can be set to different RAID levels for the purpose of allowing data of different levels of importance to be stored in different locations so that the low-end RAID unit can be nonetheless versatile to use in data storage.

The multi-volume disk array management method and system according to the invention is essentially based on the following functions: (1) logically dividing the storage space of each of the disks in the multi-disk storage unit into a number of partitions; (2) organizing at least two selected subgroups of partitions in the disks of the multi-disk storage unit into at least two logical volumes; and (3) setting the storage property of each of the logical volumes in the multi-disk storage unit to a user-specified level of fault tolerance.

The multi-volume disk array management method and system according to the invention allows a low-end RAID unit to be nonetheless capable of being organized into two or more logical volumes which can be set to different RAID levels so as to allow data of different levels of importance to be stored in different locations with different levels of fault tolerance. This feature allows low-end RAID unit to be versatile in data storage.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an object-oriented component model of the multi-volume disk array management system according to the invention; and

FIG. 2 is a flow diagram showing the operational procedures performed by the multi-volume disk array management method and system according to the invention.

### DETAILED DESCRIPTION OF PREFERRED EMBODIMENTS

The multi-volume disk array management method and system according to the invention is disclosed in full details by way of preferred embodiments in the following with reference to the accompanying drawings.

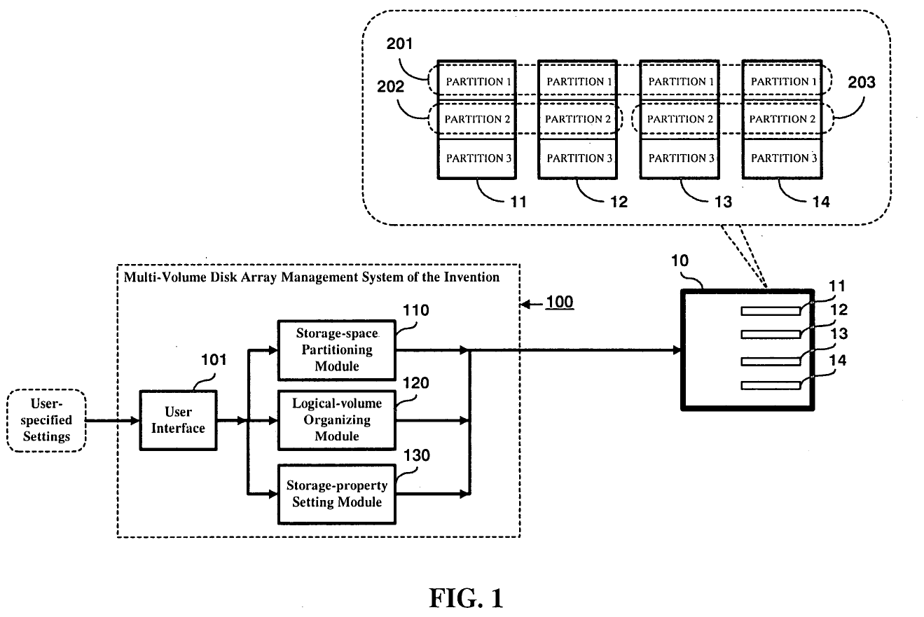

FIG. 1 is a schematic diagram showing the object-oriented component model of the multi-volume disk array management system (as the part enclosed in the dotted box indicated by the reference numeral 100). As shown, in application, the multi-volume disk array management system of the invention 100 is coupled to a multi-disk storage unit, such as a low-end RAID (Redundant Array of Independent Disks) unit 10 having a limited number of disks, for the purpose of allowing the low-end RAID unit 10 to be capable of providing two or more logical volumes for storing data of different levels of importance in two or more locations (i.e., logical volumes) in the RAID unit 10 with different levels of fault tolerance. In the embodiment of FIG. 1, for example, assume the low-end RAID unit 10 contains only 4 disks 11, 12, 13, 14.

In practice, the multi-volume disk array management system of the invention 100 can be implemented via software and installed on the server (not shown) where the RAID unit 10 is installed. The object-oriented component model of the network-based server code auto upgrade system of the invention 100 comprises the following components: (a) a user interface 101; (b) a storage-space partitioning module 110; (c) a logical-volume organizing module 120; and (d) a storage-property setting module 130.

The user interface 101 allows the user to specify and input required settings to the multi-volume disk array management system of the invention 100. These user-specified settings include: (1) user-specified partition information about the creation of new partitions or deletion of existing partitions in the storage space of each of the disks 11, 12, 13, 14 in the RAID unit 10; (2) user-specified volume information about the creation of new logical volumes from the existing partitions in the RAID unit 10; (3) user-specified storage properties that specify the storage property of each logical volume in the RAID unit 10 (i.e., which RAID level is assigned to each logical volume in the RAID unit 10), and so on. These three items of user-specified settings are transferred respectively to the storage-space partitioning module 110, the logical-volume organizing module 120, and the storage-property setting module 130 for these modules 110, 120, 130 to perform their functions based on these settings.

The storage-space partitioning module 110 is capable of logically dividing the storage space of each of the disks 11, 12, 13, 14 in the RAID unit 10 into a number of partitions based on the user-specified settings from the user interface 101. In the embodiment of FIG. 1, for example, the storage space of each of the disks 11, 12, 13, 14 is divided into three partitions: PARTITION 1, PARTITION 2, and PARTITION 3.

The logical-volume organizing module 120 is capable of organizing two or more selected subgroups of the existing partitions in the disks 11, 12, 13, 14 of the RAID unit 10 into two or more logical volumes based on the user-specified settings from the user interface 101. In the embodiment of FIG. 1, for example, PARTITION 1 in the first disk 11, PARTITION 1 in the second disk 12, PARTITION 1 in the third disk 13, and PARTITION 1 in the fourth disk 14 are user-specified to be organized into a first logical volume 201; PARTITION 2 in the first disk 11 and PARTITION 2 in the second disk 12 are organized into a second logical volume 202; and PARTITION 2 in the third disk 13 and PARTITION 2 in the fourth disk 14 are organized into a third logical volume 203.

The storage-property setting module 130 is capable of setting the storage property of each of the logical volumes 201, 202, 203 to a user-specified RAID level of fault tolerance, such as RAID Level 0, RAID Level 1, RAID Level 2, RAID Level 3, RAID Level 4, RAID Level 5, RAID Level 6, or RAID Level 10, and so on.

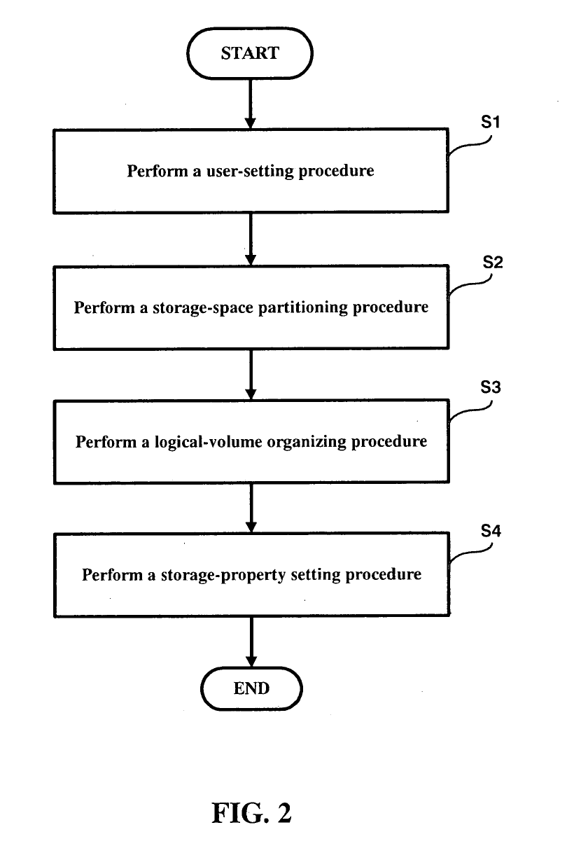

FIG. 2 is a flow diagram showing the operational procedures performed by the multi-volume disk array management system of the invention 100.

Referring to FIG. 2 together with FIG. 1, the first step S1 is to perform a user-setting procedure, wherein the user interface 101 is activated to allow the user to specify the following settings: (1) user-specified partition information about the creation of new partitions or deletion of existing partitions in the storage space of each of the disks 11, 12, 13, 14 in the RAID unit 10; (2) user-specified volume information about the creation of new logical volumes from the existing partitions in the RAID unit 10; (3) user-specified storage properties that specify the storage property of each logical volume in the RAID unit 10 (i.e., which RAID level is assigned to each logical volume in the RAID unit 10), and so on. These three items of user-specified settings are then transferred respectively to the storage-space partitioning module 110, the logical-volume organizing module 120, and the storage-property setting module 130 for these modules 110, 120, 130 to perform their functions based on these settings in subsequent steps.

In the case of the RAID unit 10 being controlled by the Linux operation system, for example, the user interface 101 can utilize Linux's FDISK disk management utility to perform partitioning tasks on the disks 11, 12, 13, 14 in the RAID unit 10. Linux's FDISK disk management utility is a well-known software tool in the information industry, so detailed description thereof will not be given here in this specification.

In the next step S2, a storage-space partitioning procedure is performed, wherein the storage-space partitioning module 110 is activated to logically divide the storage space of each of the disks 11, 12, 13, 14 in the RAID unit 10 into a number of partitions based on the user-specified settings from the user interface 101. Preferably, the partitions are set to be all equal in size. In the embodiment of FIG. 1, for example, the storage space of each of the disks 11, 12, 13, 14 is divided into three partitions: PARTITION 1, PARTITION 2, and PARTITION 3.

In the next step S3, a logical-volume organizing procedure is performed, wherein the logical-volume organizing module 120 is activated to organize two or more user-specified subgroups of partitions in the disks 11, 12, 13, 14 of the RAID unit 10 into two or more logical volumes based on the user-specified settings from the user interface 101.

In the embodiment of FIG. 1, for example, a first subgroup of partitions, including PARTITION 1 in the first disk 11, PARTITION 1 in the second disk 12, PARTITION 1 in the third disk 13, and PARTITION 1 in the fourth disk 14 are user-specified to be organized into a first logical volume 201; a second subgroup of partitions, including PARTITION 2 in the first disk 11 and PARTITION 2 in the second disk 12 are user-specified to be organized into a second logical volume 202; and a third subgroup of partitions, including PARTITION 2 in the third disk 13 and PARTITION 2 in the fourth disk 14 are user-specified to be organized into a third logical volume 203.

In the next step S4, a storage-property setting procedure is performed, wherein the storage-property setting module 130 is activated to set the storage property of each of the logical volumes 201, 202, 203 in the RAID unit 10 to a user-specified RAID level of fault tolerance, such as RAID Level 0, RAID Level 1, RAID Level 2, RAID Level 3, RAID Level 4, RAID Level 5, RAID Level 6, or RAID Level 10, and so on. For example, based on user-specified settings, the first logical volume 201 can be set to RAID Level 5; the second logical volume 202 can be set to RAID Level 1; and the third logical volume 203 can be set to RAID Level 0. This allows the low-end RAID unit 10 to have the capability of storing data of three different levels of importance in three different locations (i.e., three different logical volumes) in the RAID unit 10 at three different levels of fault tolerance.

In conclusion, the invention provides a multi-volume disk array management method and system, which is designed for use with a multi-disk storage unit, such as a low-end RAID unit having a limited number of disks, for the purpose of allowing the low-end RAID unit to be nonetheless capable of providing two or more logical volumes for storing data of different levels of importance in different locations with different levels of fault tolerance. The multi-volume disk array management method and system according to the invention is essentially based on the following functions: (1) logically dividing the storage space of each of the disks in the multi-disk storage unit into a number of partitions; (2) organizing at least two selected subgroups of partitions in the disks of the multi-disk storage unit into at least two logical volumes; and (3) setting the storage property of each of the logical volumes in the multi-disk storage unit to a user-specified level of fault tolerance. The multi-volume disk array management method and system according to the invention allows a low-end RAID unit to be nonetheless capable of being organized into two or more logical volumes which can be set to different RAID levels so as to allow data of different levels of importance to be stored in different locations with different levels of fault tolerance. This feature allows low-end RAID unit to be versatile in data storage.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A multi-volume disk array management method for use on a multi-disk storage unit having a number of disks for the purpose of allowing the multi-disk storage unit to provide at least two logical volumes for storing data in the logical volumes with at least two levels of fault tolerance;
the multi-volume disk array management method comprising:
(1) logically dividing the storage space of each of the disks in the multi-disk storage unit into a number of partitions;
(2) organizing at least two selected subgroups of partitions in the disks of the multi-disk storage unit into at least two logical volumes; and
(3) setting the storage property of each of the logical volumes in the multi-disk storage unit to a user-specified level of fault tolerance.

2. The multi-volume disk array management method of claim 1, wherein the multi-disk storage unit is a RAID-compliant storage unit.

3. The multi-volume disk array management method of claim 1, wherein in said step (1), Linux's FDISK disk management utility is utilized to logically divide the storage space of each of the disks in the multi-disk storage unit into a number of partitions.

4. The multi-volume disk array management method of claim 1, wherein in said step (1), all the partitions are set to be equal in size.

5. The multi-volume disk array management method of claim 2, wherein in said step (3), each user-specified level of fault tolerance is a RAID-compliant level of fault tolerance.

6. A multi-volume disk array management system for use with a multi-disk storage unit having a number of disks for the purpose of allowing the multi-disk storage unit to provide at least two logical volumes for storing data in the logical volumes with at least two levels of fault tolerance;
the multi-volume disk array management system comprising:
a user interface for receiving user-specified settings related to the management of the overall storage space of the multi-disk storage unit;
a storage-space partitioning module, which is capable of logically dividing the storage space of each of the disks in the multi-disk storage unit into a number of partitions based on the user-specified settings from the user interface;
a logical-volume organizing module, which is capable of organizing at least two selected subgroups of partitions in the disks of the multi-disk storage unit into at least two logical volumes based on the user-specified settings from the user interface; and
a storage-property setting module, which is capable of setting the storage property of each of the logical volumes in the multi-disk storage unit to a user-specified level of fault tolerance based on the user-specified settings from the user interface.

7. The multi-volume disk array management system of claim 6, wherein the multi-disk storage unit is a RAID-compliant storage unit.

8. The multi-volume disk array management system of claim 6, wherein the storage-space partitioning module is Linux's FDISK disk management utility.

9. The multi-volume disk array management system of claim 6, wherein the partitions created by the storage-space partitioning module are all equal in size.

10. The multi-volume disk array management system of claim 7, wherein the user-specified level of fault tolerance is based on the RAID-compliant levels of fault tolerance.
